(19) United States
(12) Patent Application Publication
(10) Pub. No.: US 2026/0100608 A1
(43) Pub. Date: Apr. 9, 2026

(54) WIRELESS POWER TRANSFER SYSTEM, AND POWER CONTROL METHOD AND APPARATUS THEREFOR

(71) Applicant: ELECTRONICS AND TELECOMMUNICATIONS RESEARCH INSTITUTE, Daejeon (KR)

(72) Inventors: Kye Seok YOON, Daejeon (KR); Gwang Zeen KO, Daejeon (KR); Sang Won KIM, Daejeon (KR); Seong Min KIM, Daejeon (KR); In Kui CHO, Daejeon (KR)

(73) Assignee: ELECTRONICS AND TELECOMMUNICATIONS RESEARCH INSTITUTE, Daejeon (KR)

(21) Appl. No.: 19/348,921

(22) Filed: Oct. 3, 2025

(30) Foreign Application Priority Data
Oct. 8, 2024 (KR) 10-2024-0136881

(51) Int. Cl. H02J 50/40; H02J 50/12; H02J 50/80

(52) U.S. Cl. CPC H02J 50/40; H02J 50/12; H02J 50/80

(57) ABSTRACT

The present invention relates to a wireless power transfer system, which includes a first receiver configured to wirelessly receive power, a second receiver configured to wirelessly receive power, and a transmitter configured to modulate power transmitted to the first receiver and the second receiver according to power actually transmitted to the first receiver and the second receiver, thereby evenly distributing the power to two independent receivers, a first receiver and a second receiver, using bidirectional coils and increasing power efficiency.

### CROSS-REFERENCE TO RELATED APPLICATION

This application claims priority to and the benefit of Korean Patent Application No. 10-2024-0136881, filed on Oct. 8, 2024, the disclosure of which is incorporated herein by reference in its entirety.

### BACKGROUND

### 1. Field of the Invention

The present invention relates to a wireless power transfer system, and a power control method and apparatus therefor.

### 2. Discussion of Related Art

Wireless power transfer technology is a technology that does not use wires and uses coils to transfer energy from a source to a load. The principles of wireless power transfer are based on two laws: Fleming's law, which states that when a current flows through a conductor, a magnetic field is generated, and Lenz's law, which states that when a magnetic flux changes, an induced electromotive force is generated within a coil in a direction that hinders the change.

Meanwhile, due to the popularization of smartphones, interest in wireless power transfer technology, which allows users to freely charge their batteries anytime, anywhere without a wired charger, is increasing.

Further, as the number of electric vehicle users increases, research is actively being conducted on wireless charging technology that provides freedom in battery charging while being safe from short circuits and disconnections.

Efficiency is the most important factor in wireless power transfer systems. Even when the wireless power transfer systems provide convenient services, when efficiency is low, the power loss is likely to result in heat, potentially leading to accidents. The conventional wireless power transfer system utilizes one transmitting coil and one receiving coil, and various methods, such as matching methods, control methods, antenna structures, etc., have been proposed for high-efficiency operation.

### SUMMARY OF THE INVENTION

The present invention is directed to providing a wireless power transfer system capable of increasing power efficiency by evenly distributing power to two independent receivers using bidirectional coils, and a power control method and apparatus therefor.

According to an aspect of the present invention, there is provided a wireless power transfer system which includes a first receiver configured to wirelessly receive power, a second receiver configured to wirelessly receive power, and a transmitter configured to modulate power transmitted to the first receiver and the second receiver according to power actually transmitted to the first receiver and the second receiver.

The first receiver and the second receiver may be independently disposed to be spaced apart from each other.

The transmitter may include a transmitting coil through which power is transmitted to the first receiver and the second receiver, an inverter that converts DC input power into AC power, and a processor that controls the inverter according to the power actually transmitted to the first receiver and the second receiver through the transmitting coil to modulate the power transmitted from the transmitting coil to the first receiver and the second receiver.

The processor may control a duty of the inverter to adjust a total amount of power of the first receiver and the second receiver.

The processor may compare a sum of a first voltage applied on a first receiving coil of the first receiver and a second voltage applied on a second receiving coil of the second receiver with a preset target voltage and control the duty of the inverter according to a result of the comparison.

The processor may control an operating frequency of the inverter to adjust a power balance between the first receiver and the second receiver.

When a sum of a first voltage applied on a first receiving coil of the first receiver and a second voltage applied on a second receiving coil of the second receiver matches a preset target voltage, the processor may compare the first voltage with the second voltage and control the operating frequency of the inverter according to a result of the comparison.

A resonant frequency of the first receiver and a resonant frequency of the first receiver may be different from each other.

According to another aspect of the present invention, there is provided a power control apparatus for a wireless power transfer system, which includes a transmitting coil through which power is transmitted to a first receiver and a second receiver which wirelessly receive power, an inverter configured to convert DC input power into AC power, and a processor configured to modulate the power transmitted from the transmitting coil to the first receiver and the second receiver according to the power actually transmitted to the first receiver and the second receiver through the transmitting coil.

The processor may control a duty of the inverter to adjust a total amount of power of the first receiver and the second receiver.

The processor may compare a sum of a first voltage applied on a first receiving coil of the first receiver and a second voltage applied on a second receiving coil of the second receiver with a preset target voltage and control the duty of the inverter according to a result of the comparison.

The processor may control an operating frequency of the inverter to adjust a power balance between the first receiver and the second receiver.

When a sum of a first voltage applied on a first receiving coil of the first receiver and a second voltage applied on a second receiving coil of the second receiver matches a preset target voltage, the processor may compare the first voltage with the second voltage and control the operating frequency of the inverter according to a result of the comparison.

According to still another aspect of the present invention, there is provided a power control method for a wireless power transfer system, which includes controlling, by a processor, an inverter to wirelessly transmit power to a first receiver and a second receiver through a transmitting coil, and modulating, by the processor, the power transmitted from the transmitting coil to the first receiver and the second receiver according to the power actually transmitted to the first receiver and the second receiver through the transmitting coil.

In the modulating of the power, the processor may control a duty of the inverter to adjust a total amount of power of the first receiver and the second receiver.

In the modulating of the power, the processor may compare a sum of a first voltage applied on a first receiving coil of the first receiver and a second voltage applied on a second receiving coil of the second receiver with a preset target voltage and control the duty of the inverter according to a result of the comparison.

In the modulating of the power, the processor may control an operating frequency of the inverter to adjust a power balance between the first receiver and the second receiver.

In the modulating of the power, when a sum of a first voltage applied on a first receiving coil of the first receiver and a second voltage applied on a second receiving coil of the second receiver matches a preset target voltage, the processor may compare the first voltage with the second voltage and control the operating frequency of the inverter according to a result of the comparison.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram of a wireless power transfer system and a power control apparatus according to an embodiment of the present invention;

FIG. 2 is a graph showing a voltage with respect to an operating frequency according to an embodiment of the present invention; and

FIG. 3 is a flowchart of a power control method for a wireless power transfer system according to an embodiment of the present invention.

### DETAILED DESCRIPTION OF EXEMPLARY EMBODIMENTS

Hereinafter, examples of a power control method and apparatus for a wireless power transfer system according to embodiments of the present invention will be described. In this process, thicknesses of lines, sizes of components, and the like illustrated in the drawings may be exaggerated for clarity and convenience of description. Further, some terms which will be described below are defined in consideration of functions in the present invention and meanings may vary depending on, for example, a user or operator's intentions or customs. Therefore, the meanings of these terms should be interpreted based on the scope throughout this specification.

Embodiments of the present invention may be implemented in several different forms and are not limited to embodiments described herein. In addition, parts irrelevant to description are omitted in the drawings in order to clearly explain the present invention. Similar parts are denoted by similar reference numerals throughout this specification.

Throughout this specification, when a portion “includes” an element, another element may be further included, rather than excluding the presence of other elements, unless otherwise described.

The implementations described herein may be conducted, for example, as a method or process, a device, a software program, a data stream, or signals. Even when discussed only in the context of a single form of implementation (e.g., discussed only as a method), the implementation of the features discussed may also be conducted in other forms (e.g., as a device or a program). A device may be implemented as appropriate hardware, software, firmware, etc. A method may be implemented in a device, such as a processor, which generally refers to a processing device including, for example, a computer, a microprocessor, an integrated circuit, a programmable logic device, or the like.

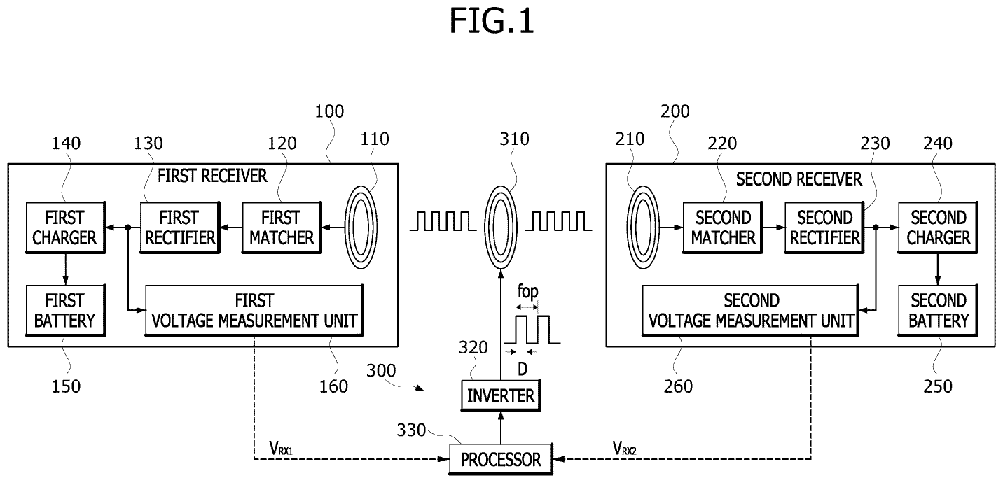

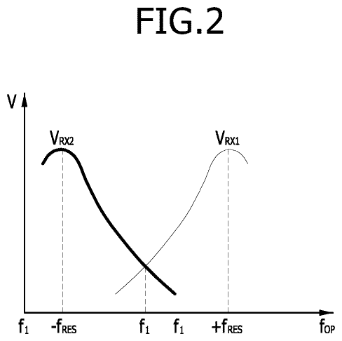

FIG. 1 is a block diagram of a wireless power transfer system and a power control apparatus according to an embodiment of the present invention, and FIG. 2 is a graph showing a voltage with respect to an operating frequency according to an embodiment of the present invention.

Referring to FIG. 1, the wireless power transfer system according to the embodiment of the present invention may include a first receiver 100, a second receiver 200, and a transmitter 300.

The first receiver 100 may receive power wirelessly transmitted from the transmitter 300. The first receiver 100 may include a first receiving coil 110, a first matcher 120, a first rectifier 130, a first charger 140, a first battery 150, and a first voltage measurement unit 160.

The first receiving coil 110 may be configured to receive the power transmitted from the transmitter 300 and coupled to a transmitting coil 310 of the transmitter 300 in an electromagnetic induction or magnetic resonance manner.

The first matcher 120 may perform impedance matching between the first receiving coil 110 and the transmitting coil 310 and, to this end, may include a plurality of capacitors therein.

The first rectifier 130 may convert an AC voltage generated by the first receiving coil 110 into a DC voltage. The first rectifier 130 may include a full bridge, a half bridge, or the like and may be implemented using a semiconductor switching device, for example, a metal-oxide-semiconductor field-effect transistor (MOSFET) or an insulated-gate bipolar transistor (IGBT).

The first charger 140 may charge the first battery 150 with the DC voltage converted by the first rectifier 130. The first charger 140 may convert the DC voltage output from the first rectifier 130 into a voltage appropriate for charging the first battery 150.

The first battery 150 may charge the voltage transmitted from the first charger 140. The first battery 150 may be a lithium-ion battery, and the type of the first battery 150 is not particularly limited.

The first voltage measurement unit 160 may measure a first voltage V_{RX1} applied on the first receiving coil 110. The first voltage V_{RX1} may be the DC voltage output from the first rectifier 130.

The first voltage measurement unit 160 may transmit the first voltage V_{RX1} to the transmitter 300 through various communication networks.

The communication networks may include 3^{rd} Generation Partnership Project (3GPP), Long-Term Evolution (LTE), 5^{th} Generation (5G), Worldwide Interoperability for Microwave Access (WiMAX), wired and wireless Internet, a local area network (LAN), a wireless LAN, a wide area network (WAN), a personal area network (PAN), Bluetooth, Wi-Fi, etc., but the present invention is not particularly limited.

The second receiver 200 may include a second receiving coil 210, a second matcher 220, a second rectifier 230, a second charger 240, a second battery 250, and a second voltage measurement unit 260.

The second receiver 200 may receive the power wirelessly transmitted from the transmitter 300. The second receiver 200 may include the second receiving coil 210, the second matcher 220, the second rectifier 230, the second charger 240, the second battery 250, and the second voltage measurement unit 260.

The second receiving coil 210 may be configured to receive the power transmitted from the transmitter 300 and coupled to the transmitting coil 310 of the transmitter 300 in an electromagnetic induction or magnetic resonance manner.

The second matcher 220 may perform impedance matching between the second receiving coil 210 and the transmitting coil 310 and, to this end, may include a plurality of capacitors.

The second rectifier 230 may convert an AC voltage generated by the second receiving coil 210 into a DC voltage. The second rectifier 230 may include a full bridge, a half bridge, or the like and may be implemented using a semiconductor switching device such as a MOSFET or an IGBT.

The second charger 240 may charge the second battery 250 with the DC voltage converted by the second rectifier 230. The second charger 240 may convert the DC voltage output from the second rectifier 230 into a voltage appropriate for charging the second battery 250.

The second battery 250 may charge the voltage transmitted from the second charger 240. The second battery 250 may be a lithium-ion battery, and the type of the second battery 250 is not particularly limited.

The second voltage measurement unit 260 may measure a second voltage V_{RX2} applied on the second receiving coil 210. The first voltage V_{RX1} may be the DC voltage output from the second rectifier 230.

The second voltage measurement unit 260 may transmit the second voltage V_{RX2} to the transmitter 300 through various communication networks.

The first receiver 100 and the second receiver 200 may be independently disposed to be physically spaced apart from each other. That is, the first receiver 100 and the second receiver 200 may be formed with the same structure to be physically spaced from each other and wirelessly receive power from a single transmitter 300.

The transmitter 300 may wirelessly transmit the power to the first receiver 100 and the second receiver 200. In this process, the transmitter 300 may modulate the power transmitted to the first receiver 100 and the second receiver 200 according to power actually transmitted to the first receiver 100 and the second receiver 200 to control a total amount of the power received by the first receiver 100 and the second receiver 200 and a power balance between the power received by the first receiver 100 and the power received by the second receiver 200.

The transmitter 300 may include the transmitting coil 310, an inverter 320, and a processor 330.

The transmitting coil 310 may be configured to transmit power to the first receiver 100 and the second receiver 200.

The inverter 320 may convert DC input power into AC power. The inverter 320 may adjust its duty D or operating frequency f_{OP} in response to a control signal of the processor 330. The total amount of the power received by the first receiver 100 and the second receiver 200 may be adjusted based on the duty D of the inverter 320. The power balance between the power received by the first receiver 100 and the power received by the second receiver 200 may be controlled based on the operating frequency f_{OP} of the inverter 320. The inverter 320 may be implemented using any one of various semiconductor switching devices, for example, a MOSFET or an IGBT.

The processor 330 may be connected to a memory (not illustrated) and execute instructions stored in the memory. The processor 330 may execute the instructions stored in the memory to control at least one other component (e.g., hardware or software component) connected to the processor 330 and perform various data processing or calculations.

The memory may store various types of data used by the processor 330. The data may include instructions for performing operations or steps according to the embodiments of the present invention. That is, the memory may store an instruction that modulates the power transmitted from the transmitting coil 310 to the first receiver 100 and the second receiver 200 according to the power actually transmitted to the first receiver 100 and the second receiver 200 through the transmitting coil 310. The memory may include at least one storage medium among a flash memory type, a hard disk type, a multimedia card micro type, a card type memory, a random access memory (RAM), a static RAM (SRAM), a read-only memory (ROM), a programmable ROM (PROM), an erasable programmable ROM (EPROM), and an electrically erasable programmable ROM (EEPROM).

Further, the processor 330 may be formed as components for performing each function separately at the hardware, software, or logic levels. In this case, dedicated hardware may be used to perform each function. To this end, the processor 330 may be implemented as at least one of application specific integrated circuits (ASICs), a digital signal processor (DSP), programmable logic devices (PLDs), field programmable gate arrays (FPGAs), a central processing unit (CPU), microcontrollers, and microprocessors or include at least one thereof.

The processor 330 may be implemented as a CPU or a system on chip (SoC), may control a plurality of hardware or software components connected to the processor 330 by running an operating system or application and perform various data processing and calculations. The processor 330 may be configured to execute at least one command stored in the memory and store result data of the execution in the memory. The processor 330 may set initial duty and an initial operating frequency f₁ for the duty D and operating frequency f_{OP} of the inverter 320. The inverter 320 may operate with the initial duty of and the initial operating frequency f₁ when power transfer to the first receiver 100 and the second receiver 200 begins and may then adjust the duty D and operating frequency f_{OP} according to the first voltage V_{RX1} or the second voltage V_{RX2}.

The processor 330 may receive the first voltage V_{RX1} measured by the first voltage measurement unit 160 from the first receiver 100 and receive the second voltage V_{RX2} measured by the second voltage measurement unit 260 from the second receiver 200, through the communication network.

The processor 330 may control the duty D and operating frequency f_{OP} of the inverter 320 to transmit the power from the first receiving coil 110 to the first receiver 100 and the second receiver 200. In this case, in order to maintain the power balance between the first receiver 100 and the second receiver 200, it is possible to modulate the power transmitted to the first receiver 100 and the second receiver 200 by adjusting the duty D and operating frequency f_{OP} of the inverter 320 on the basis of the first voltage V_{RX1} and the second voltage V_{RX2}.

Ideally, when the first receiving coil 110 and the second receiving coil 210 are positioned at the same distance from the transmitting coil 310, the strength of a magnetic field of the transmitting coil 310 is the same, and thus the same power may be supplied to the first receiving coil 110 and the second receiving coil 210. However, since the distances of the first receiving coil 110 and the second receiving coil 210 from the transmitting coil 310 may be different from each other, the power or voltages received by the first receiving coil 110 and the second receiving coil 210 may be different. In such an asymmetric situation, overall power efficiency may be reduced. Accordingly, the processor 330 may control the duty D of the inverter 320 to control the total amount of power of the first receiving coil 110 and the second receiving coil 210 and control the operating frequency f_{OP} of the inverter 320 to control the power balance between the first receiving coil 110 and the second receiving coil 210. Here, resonant frequencies of the first receiver 100 and the second receiver 200 may be set differently by the first matcher 120 and the second matcher 220.

More specifically, first, the processor 330 may sum the first voltage V_{RX1} and the second voltage V_{RX2} that are received from the first receiver 100 and the second receiver 200.

The processor 330 may compare the sum of the first voltage V_{RX1} and the second voltage V_{RX2} with a preset target voltage. The target voltage may be a voltage corresponding to target power to be obtained through the first receiver 100 and the second receiver 200.

When the sum of the first voltage V_{RX1} and the second voltage V_{RX2} is lower than the target voltage, the processor 330 may increase the duty D of the inverter 320. In this case, the processor 330 may gradually increase the duty D of the inverter 320 by a preset setting increase duty.

When the sum of the first voltage V_{RX1} and the second voltage V_{RX2} is higher than the target voltage, the processor 330 may decrease the duty D of the inverter 320. In this case, the processor 330 may gradually decrease the duty D of the inverter 320 by a preset setting decrease duty.

In this way, the processor 330 may increase the duty D of the inverter 320 when the sum of the first voltage V_{RX1} and the second voltage V_{RX2} is lower than the target voltage, and decrease the duty D of the inverter 320 when the sum of the first voltage V_{RX1} and the second voltage V_{RX2} is higher than the target voltage, to make the sum of the first voltage V_{RX1} and the second voltage V_{RX2} to match the target voltage, thereby adjusting the total amount of the power received by the first receiver 100 and the second receiver 200.

Meanwhile, when the sum of the first voltage V_{RX1} and the second voltage V_{RX2} matches the target voltage, the processor 330 may compare the first voltage V_{RX1} with the second voltage V_{RX2}.

When the first voltage V_{RX1} is higher than the second voltage V_{RX2}, the processor 330 may increase the operating frequency f_{OP} of the inverter 320. In this case, the processor 330 may gradually increase the operating frequency f_{OP} of the inverter 320 by a preset setting increase operating frequency.

When the first voltage V_{RX1} is lower than the second voltage V_{RX2}, the processor 330 may decrease the operating frequency f_{OP} of the inverter 320. In this case, the processor 330 may gradually decrease the operating frequency f_{OP} of the inverter 320 by a preset setting decrease operating frequency.

Referring to FIG. 2, in a state in which the resonant frequency of the first receiver 100 is set to be higher than the initial operating frequency f₁ (f₁+f_{RES}) and the resonant frequency of the second receiver 200 is set to be lower than the initial operating frequency f₁ (f₁−f_{RES}), when the first voltage V_{RX1} is higher than the first voltage V_{RX1}, the processor 330 may decrease the operating frequency f_{OP} until the first voltage V_{RX1} and the second voltage V_{RX2} become equal. Conversely, when the second voltage V_{RX2} is higher than the first voltage V_{RX1}, the processor 330 may increase the operating frequency f_{OP} until the first voltage V_{RX1} and the second voltage V_{RX2} become equal.

As described above, the processor 330 may control the total amount of power of the first receiver 100 and the second receiver 200 by adjusting the duty D and control the power balance between the first receiver 100 and the second receiver 200 by adjusting the operating frequency f_{OP}.

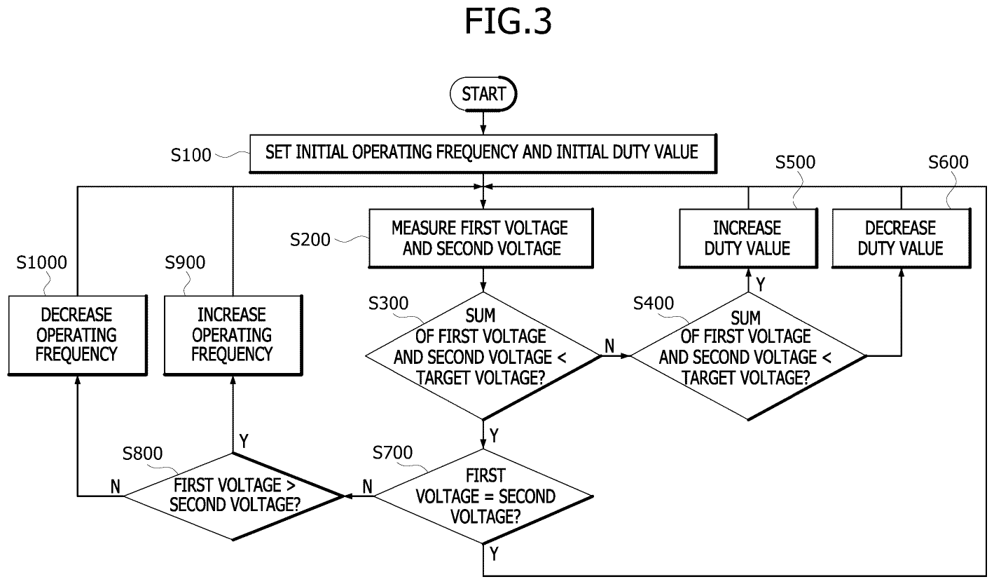

Hereinafter, a power control method for a wireless power transfer system according to an embodiment of the present invention will be described with reference to FIG. 3.

Referring to FIG. 3, first, when power transfer begins, a processor 330 may set initial duty and an initial operating frequency f₁ for duty D and an operating frequency f_{OP} of an inverter 320 (S100).

The processor 330 may control the inverter 320 according to the initial duty and the initial operating frequency f₁ to transmit power to each of a first receiving coil 110 and a second receiving coil 210 through a transmitting coil 310.

In this case, the first receiving coil 110 of a first receiver 100 may receive the power transmitted from the transmitting coil 310, a first matcher 120 may perform impedance matching between the first receiving coil 110 and the transmitting coil 310, a first rectifier 130 may convert an AC voltage generated from the first receiving coil 110 into a DC voltage, and a first charger 140 may charge a first battery 150 with the DC voltage converted by the first rectifier 130. Further, the second receiving coil 210 of a second receiver 200 may receive the power transmitted from the transmitting coil 310, and a second matcher 220 may perform impedance matching between the second receiving coil 210 and the transmitting coil 310. A second rectifier 230 may convert an AC voltage generated from the second receiving coil 210 into a DC voltage, and a second charger 240 may charge a second battery 250 with the DC voltage converted by the second rectifier 230.

In this case, a first voltage measurement unit 160 may measure a first voltage V_{RX1} applied on the first receiving coil 110, and a second voltage measurement unit 260 may measure a second voltage V_{RX2} applied on the second receiving coil 210 (S200). The first voltage measurement unit 160 and the second voltage measurement unit 260 may respectively transmit the first voltage V_{RX1} and the second voltage V_{RX2} to the processor 330 through a communication network.

The processor 330 may sum the first voltage V_{RX1} and the second voltage V_{RX2} that are received from the first voltage measurement unit 160 and the second voltage measurement unit 260.

The processor 330 may determine whether the sum of the first voltage V_{RX1} and the second voltage V_{RX2} matches a preset target voltage (S300).

As a result of the determination in operation S300, when it is determined that the sum of the first voltage V_{RX1} and the second voltage V_{RX2} does not match the target voltage, the processor 330 may determine whether the sum of the first voltage V_{RX1} and the second voltage V_{RX2} is lower than the target voltage (S400).

As a result of the determination in operation S400, when it is determined that the sum of the first voltage V_{RX1} and the second voltage V_{RX2} is lower than the target voltage, the processor 330 may gradually increase the duty D of the inverter 320 by a setting increase duty (S500).

On the other hand, as a result of the determination in operation S400, when it is determined that the sum of the first voltage V_{RX1} and the second voltage V_{RX2} is higher than the target voltage, the processor 330 may decrease the duty D of the inverter 320 by a setting decrease duty (S600).

In this way, the processor 330 may adjust the duty D of the inverter 320 so that the sum of the first voltage V_{RX1} and the second voltage V_{RX2} matches the target voltage, to adjust the total amount of the power received by the first receiver 100 and the second receiver 200.

Meanwhile, as a result of the determination in operation S300, when it is determined that the sum of the first voltage V_{RX1} and the second voltage V_{RX2} matches the target voltage, the processor 330 may determine whether the first voltage V_{RX1} and the second voltage V_{RX2} match (S700).

As a result of the determination in operation S700, when it is determined that the first voltage V_{RX1} and the second voltage V_{RX2} do not match, the processor 330 may determine whether the first voltage V_{RX1} is higher than the second voltage V_{RX2} (S800).

As a result of the determination in operation S800, when it is determined that the first voltage V_{RX1} is higher than the second voltage V_{RX2}, the processor 330 may increase the operating frequency f_{OP} of the inverter 320 by a setting increase operating frequency (S900).

On the other hand, as a result of the determination in operation S800, when it is determined that the first voltage V_{RX1} is lower than the second voltage V_{RX2}, the processor 330 may decrease the operating frequency f_{OP} of the inverter 320 by a setting decrease operating frequency (S100).

In this way, the processor 330 may adjust the operating frequency f_{OP} of the inverter 320 so that the first voltage V_{RX1} and the second voltage V_{RX2} match, to control a power balance between the first receiver 100 and the second receiver 200.

In this way, in the power control method and apparatus for the wireless power transfer system according to the embodiments of the present invention, power efficiency can be increased by evenly distributing power to two independent receivers using bidirectional coils.

In the power control method and apparatus for the wireless power transfer system according to one aspect of the present invention, power efficiency can be increased by evenly distributing power to two independent receivers using bidirectional coils.

Meanwhile, the term “unit” used herein may include a unit composed of hardware, software, or firmware, and for example, may be used interchangeably with a term such as “logic,” “logic block,” “component,” or “circuit.” A unit may be an integrally constituted part or a minimum unit or a part thereof that performs one or more functions. For example, according to an embodiment, a “unit” may be implemented as an ASIC.

While the present invention has been described with reference to embodiments illustrated in the accompanying drawings, the embodiments should be considered in a descriptive sense only, and it should be understood by those skilled in the art that various alterations and other equivalent embodiments may be made. Therefore, the scope of the present invention should be defined by only the following claims.

What is claimed is:

1. A wireless power transfer system comprising:
a first receiver configured to wirelessly receive power;
a second receiver configured to wirelessly receive power; and
a transmitter configured to modulate power transmitted to the first receiver and the second receiver according to power actually transmitted to the first receiver and the second receiver.

2. The wireless power transfer system of claim 1, wherein the first receiver and the second receiver are independently disposed to be spaced apart from each other.

3. The wireless power transfer system of claim 1, wherein the transmitter includes:
a transmitting coil through which power is transmitted to the first receiver and the second receiver;
an inverter that converts DC input power into AC power; and
a processor that controls the inverter according to the power actually transmitted to the first receiver and the second receiver through the transmitting coil to modulate the power transmitted from the transmitting coil to the first receiver and the second receiver.

4. The wireless power transfer system of claim 3, wherein the processor controls a duty of the inverter to adjust a total amount of power of the first receiver and the second receiver.

5. The wireless power transfer system of claim 4, wherein the processor compares a sum of a first voltage applied on a first receiving coil of the first receiver and a second voltage applied on a second receiving coil of the second receiver with a preset target voltage and controls the duty of the inverter according to a result of the comparison.

6. The wireless power transfer system of claim 3, wherein the processor controls an operating frequency of the inverter to adjust a power balance between the first receiver and the second receiver.

7. The wireless power transfer system of claim 6, wherein, when a sum of a first voltage applied on a first receiving coil of the first receiver and a second voltage applied on a second receiving coil of the second receiver matches a preset target voltage, the processor compares the first voltage with the second voltage and controls the operating frequency of the inverter according to a result of the comparison.

8. The wireless power transfer system of claim 1, wherein a resonant frequency of the first receiver and a resonant frequency of the first receiver are different from each other.

9. A power control apparatus for a wireless power transfer system, the power control apparatus comprising:
a transmitting coil through which power is transmitted to a first receiver and a second receiver which wirelessly receive power;
an inverter configured to convert DC input power into AC power; and
a processor configured to modulate the power transmitted from the transmitting coil to the first receiver and the second receiver according to the power actually transmitted to the first receiver and the second receiver through the transmitting coil.

10. The power control apparatus of claim 9, wherein the processor controls a duty of the inverter to adjust a total amount of power of the first receiver and the second receiver.

11. The power control apparatus of claim 10, wherein the processor compares a sum of a first voltage applied on a first receiving coil of the first receiver and a second voltage applied on a second receiving coil of the second receiver with a preset target voltage and controls the duty of the inverter according to a result of the comparison.

12. The power control apparatus of claim 9, wherein the processor controls an operating frequency of the inverter to adjust a power balance between the first receiver and the second receiver.

13. The power control apparatus of claim 12, wherein, when a sum of a first voltage applied on a first receiving coil of the first receiver and a second voltage applied on a second receiving coil of the second receiver matches a preset target voltage, the processor compares the first voltage with the second voltage and controls the operating frequency of the inverter according to a result of the comparison.

14. A power control method for a wireless power transfer system, the power control method comprising:
controlling, by a processor, an inverter to wirelessly transmit power to a first receiver and a second receiver through a transmitting coil; and
modulating, by the processor, the power transmitted from the transmitting coil to the first receiver and the second receiver according to the power actually transmitted to the first receiver and the second receiver through the transmitting coil.

15. The power control method of claim 14, wherein, in the modulating of the power, the processor controls a duty of the inverter to adjust a total amount of power of the first receiver and the second receiver.

16. The power control method of claim 15, wherein, in the modulating of the power, the processor compares a sum of a first voltage applied on a first receiving coil of the first receiver and a second voltage applied on a second receiving coil of the second receiver with a preset target voltage and controls the duty of the inverter according to a result of the comparison.

17. The power control method of claim 14, wherein, in the modulating of the power, the processor controls an operating frequency of the inverter to adjust a power balance between the first receiver and the second receiver.

18. The power control method of claim 17, wherein, in the modulating of the power, when a sum of a first voltage applied on a first receiving coil of the first receiver and a second voltage applied on a second receiving coil of the second receiver matches a preset target voltage, the processor compares the first voltage with the second voltage and controls the operating frequency of the inverter according to a result of the comparison.
